(19) United States
(12) Patent Application Publication
(10) Pub. No.: US 2022/0260122 A1
(43) Pub. Date: Aug. 18, 2022

(54) ACTUATING DEVICE FOR A MULTI-PLATE BRAKE, AND TRANSMISSION ARRANGEMENT COMPRISING THE ACTUATING DEVICE AND THE MULTI-PLATE BRAKE

(71) Applicant: Schaeffler Technologies AG & Co. KG, Herzogenauarch (DE)

(72) Inventor: Markus HEITBAUM, Bühlertal (DE)

(73) Assignee: Schaeffler Technologies AG & Co. KG, Herzogenauarch (DE)

(21) Appl. No.: 17/625,851

(22) PCT Filed: Jun. 23, 2020
(86) PCT No.: PCT/DE2020/100531

§ 371 Date: Jan. 10, 2022

(30) Foreign Application Priority Data
Jul. 10, 2019 (DE) 102019118699.4

(51) Int. Cl. F16D 55/40; F16D 65/18

(52) U.S. Cl. CPC F16D 55/40; F16D 25/0638; F16D 2300/08; F16D 65/186

(57) ABSTRACT

An actuating device with an actuating piston for transmitting an actuating force to a multi-plate device, with a housing section that receives the actuating piston for movement between an open and a closed position. The housing section has a pressure chamber, and the actuating piston delimits the pressure chamber such that, for an increase of a fluid pressure in the pressure chamber, the actuating piston moves from the open into the closed position. A spring resets the actuating piston, and the spring is supported via a first support surface on the actuating piston and a second support surface on the housing section. The first and the second support surface are arranged situated axially opposite one another and overlapping in a radial direction, such that the spring is supported simultaneously in one axial direction on the first support surface and in an axial opposite direction on the second support surface.

### CROSS-REFERENCE TO RELATED APPLICATIONS

This application is the U.S. National Phase of PCT Appln. No. PCT/DE2020/100531, filed Jun. 23, 2020, which claims priority from German Patent Application No. 10 2019 118 699.4, filed Jul. 10, 2019, the entire disclosures of which are incorporated by reference herein.

### TECHNICAL FIELD

The disclosure relates to an actuating device for a multi-plate brake. The disclosure also relates to a transmission arrangement with the actuating device and the multi-plate brake.

### BACKGROUND

Actuating devices are known which have a piston that can be acted upon by a fluid pressure for actuating a multi-plate brake. To reset the piston, actuating devices of this type usually have a spring which pushes the piston back into an initial position. Such actuating devices are provided, for example, in automatic transmissions, in particular in double clutch systems, for motor vehicles.

The publication DE 10 2006 031 787 A1, which probably constitutes the closest prior art, discloses a multi-plate brake in an automatic transmission, with an inner multi-plate carrier and an outer multi-plate carrier, with inner plates and outer plates axially arranged alternately on the multi-plate carriers, with friction linings on the inner plates and/or outer plates, with a piston of a piston-cylinder arrangement that can be actuated by pressure medium, by means of which the inner plates and outer plates can be acted upon with a force closing the multi-plate brake, with an end multi-plate support plate remote from the piston, which forms an axial abutment for the multi-plate assembly built up by the plates, and in which the multi-plate brake and/or the components surrounding same are designed so that the plates can be wetted with a cooling oil, characterized in that the multi-plate brake is designed in such a way that, depending on the operating state thereof, the cooling oil can be guided in radially different directions over and/or through the plate assembly.

### SUMMARY

It is the object of the disclosure to create an actuating device of the type mentioned above, which is distinguished by a compact design. It is also an object of the disclosure to propose a transmission arrangement with the actuating device.

This object is achieved by an actuating device with one or more of the features disclosed herein and by a transmission arrangement with one or more of the features disclosed herein. Preferred or advantageous embodiments result from the claims, the following description, and the attached figures.

An object of the disclosure is an actuating device which is designed and/or suitable for a multi-plate device. In particular, the actuating device is designed as a hydraulically or pneumatically actuatable cylinder. The actuating device is particularly preferably designed as a single-acting cylinder, in particular a slave cylinder. The multi-plate device can be designed as a multi-plate brake, wherein a rotating component is subjected to a braking torque when the multi-plate brake is closed. Alternatively, however, the multi-plate device can also be designed as a multi-plate clutch, wherein a torque is transmitted from a rotating component to a further component when the multi-plate clutch is closed.

The actuating device has an actuating piston which is designed and/or suitable for transmitting an actuating force to the multi-plate device. The actuating piston is preferably in operative connection with the multi-plate device. The actuating force is preferably a pressure force which is axially directed with respect to the main axis of rotation. In particular, the actuating piston and the multi-plate device are arranged to be coaxial and/or concentric to one another with respect to a main axis of rotation.

The actuating device has a housing section which is designed and/or suitable in particular for receiving the actuating piston. In particular, the housing section is a stationary housing section which remains stationary relative to the multi-plate device. The actuating piston is received in the housing section so that it can be axially displaced between an open position and a closed position with respect to the main axis of rotation. In particular, the actuating force is transmitted to the multi-plate device in the closed position, wherein conversely in the open position there is no transmission of the actuating force.

The housing section has a pressure chamber that can be filled with a fluid, wherein the actuating piston delimits the pressure chamber. In particular, the pressure chamber is delimited in relation to the main axis of rotation at least in the axial direction and optionally additionally in the radial direction by the actuating piston, wherein a volume of the pressure chamber is changeable and/or is changed when the piston is displaced. The pressure chamber is particularly preferably filled with a hydraulic fluid. In particular, the pressure chamber is fluidically connected to the master cylinder. When the master cylinder is actuated, a fluid column is displaced in the direction of the actuating device, wherein a fluid pressure of the fluid in the pressure chamber is increased and the actuating piston is transferred from the open position to the closed position.

The actuating device has a spring device which is designed and/or suitable for resetting the actuating piston from the closed position into the open position. The spring device preferably acts on the actuating piston against the actuating force with a compressive force as a restoring force. Particularly preferably, when the actuating force or the fluid pressure is reduced, the actuating piston is automatically returned from the closed position to the open position by the spring device. In particular, the spring device comprises one or more compression springs. The multiple compression springs can preferably be arranged in a uniformly distributed manner in the direction of rotation. The at least one compression spring is preferably designed as a helical spring or a disk spring or a disk spring assembly. The spring device is supported on the actuating piston via a first support surface and on the housing section via a second support surface.

In the context of the disclosure, it is proposed that the first and the second support surface are arranged axially opposite one another. In particular, the first and the second support surface each extend in a separate radial plane with respect to the main axis of rotation. The first and the second support surface are preferably arranged so as to overlap in the axial direction. In particular, the first and the second support surface are each defined as a circular ring surface, which are arranged to be coaxial and/or congruent to one another with respect to the axis of rotation. The first support surface is preferably arranged on the actuating piston and/or formed thereby. In particular, the actuating piston forms a spring seat for the spring device. The spring device is thus supported on the first support surface in one axial direction and equally on the second support surface in an axial opposite direction. In this case, “equally” is to be understood to mean that the spring device, viewed in the radial direction, is supported on the two support surfaces at the same height. The spring device particularly preferably extends in the axial direction in relation to the main axis of rotation between the two support surfaces, wherein the compression springs preferably have the spring axes thereof aligned with one another and/or aligned to be parallel to the main axis of rotation.

The advantage of the disclosure is that a particularly compact design of the actuating device can be implemented through the two opposing support surfaces. In particular, the spring device can thus be inserted or integrated radially within the actuating piston, as a result of which a radial installation space for the actuating device can be significantly reduced. In addition, the spring device can introduce the restoring force directly into the actuating piston through the two opposing support surfaces.

In a specific embodiment it is provided that the actuating piston is designed as an annular piston and that the pressure chamber is designed as an annular space. In particular, the actuating device is designed as a ring cylinder, in particular as a concentric slave cylinder (CSC). For this purpose, the annular piston and the annular space are preferably arranged to be coaxial and/or concentric to one another with respect to the main axis of rotation.

According to this embodiment, the actuating piston has an inner and an outer cylinder section and a radial section connecting the two cylinder sections. In particular, the two cylinder sections are arranged to be concentric to one another with respect to the main axis of rotation and/or are radially spaced apart from one another and/or are aligned or opposed to one another. The actuating piston is particularly preferably designed as a sheet metal component, in particular a sheet metal ring piston. The radial section particularly preferably extends in a radial plane with respect to the main axis of rotation. An annular intermediate space, in particular surrounding the main axis of rotation, is formed between the two cylinder sections, wherein the spring device is received in the intermediate space. The first support surface is formed by the radial section. In particular, the spring device is guided between the two cylinder sections and is supported on the radial section in the axial direction.

An actuating piston is therefore proposed which, in the manner of a spring sleeve, forms a particularly stable spring seat for the spring device. In addition, the actuating piston can be manufactured particularly easily and inexpensively.

In a further specification, it is provided that the actuating device has an inner and an outer sealing device which is designed and/or suitable for sealing the actuating piston with respect to the housing section. In particular, the inner and/or the outer sealing device are designed as a contact seal. The inner and the outer sealing device are preferably each designed as a sealing ring, wherein the two sealing devices are arranged to be coaxial and/or concentric to one another with respect to the main axis of rotation.

According to this embodiment, the inner and the outer sealing devices are fixed on the housing section. In particular, the two sealing devices are each designed as a static seal, preferably as a groove sealing ring. The housing section preferably has an inner seal receptacle for receiving the inner sealing device and an outer seal receptacle for receiving the outer sealing device. In particular, the two seal receptacles are each designed as an annular recess, preferably an annular groove. Particularly preferably, the sealing devices are each received in the associated seal receptacle in a form-fitting and/or force-fitting manner, at least in the axial direction.

Thus, an actuating piston is proposed which can be designed in a particularly simple and cost-effective manner due to the arrangement of the sealing seat on the housing section. In addition, the distance between the two cylinder sections for receiving the spring device can be optimally designed.

In a further embodiment, the outer cylinder section forms an outer sealing surface for the outer sealing device and the inner cylinder section forms an inner sealing surface for the inner sealing device. In particular, the two sealing surfaces are each defined by a cylinder jacket surface of the respective cylinder section. The outer sealing device particularly preferably rests against an outer circumference of the outer cylinder section. Alternatively, however, it can also be provided that the outer sealing device rests against an inner circumference of the outer cylinder section, in particular when the pressure chamber is radially delimited by the outer cylinder section. The inner sealing device particularly preferably rests against an inner circumference of the inner cylinder section. When the actuating piston is displaced, the outer sealing surface abuts the outer sealing device and the inner sealing surface abuts the inner sealing device in a sealing manner, wherein the two sealing devices in particular remain stationary on the housing section.

It is thus a consideration of the disclosure to propose an actuating piston which is distinguished by a particularly simple and compact construction. Because the two sealing devices are in contact with the cylinder sections, the actuating piston can be designed to be particularly compact and simple to receive the spring device.

In a further embodiment, it is provided that the actuating device has a support section which is designed and/or suitable for supporting the spring device. The support section is arranged so as to protrude radially from the housing section, wherein the second support surface is formed by the support section. In principle, the support section can be molded onto the housing section. Preferably, however, the support section is designed as a separate component, wherein the support section is connected and/or connectable to the housing section in a form-fitting and/or force-fitting and/or material-fitting manner. The support section preferably extends in a flange-like manner in a radial plane of the main axis of rotation. The support section is particularly preferably arranged to be coaxial and/or concentric with the actuating piston, in particular the inner and/or the outer cylinder section.

A housing section is therefore proposed which is distinguished by a particularly compact design, wherein the actuating piston is also secured against loss by the support section.

In a further embodiment it is provided that one of the two cylinder sections, in particular in the axial direction with respect to the main axis of rotation, is made longer than the other cylinder section. The longer cylinder section is arranged at a radial distance from the support section so that the longer cylinder section can be freely displaced relative to the support section for transmitting the actuating force to the multi-plate brake. Preferably, the longer of the two cylinder sections is freely movable in the direction of the multi-plate brake and/or is supported thereon. The longer cylinder section is preferably supported on the multi-plate brake with the axial end face thereof in the axial opposite direction. In particular, the support section is received radially inside the longer support section. In particular, the shorter of the two cylinder sections can be axially displaced to a limited extent between the support section and the housing section, wherein an end stop is formed in the axial direction through the housing section, in particular a radial surface that delimits the pressure chamber, and an end stop is formed in the axial opposite direction through the support section.

It is therefore a consideration of the disclosure to propose an actuating device which is distinguished by a particularly space-saving and component-reduced design.

In a further specific development, it is provided that the housing section has a cylindrical extension. In particular, the cylindrical extension extends the pressure chamber in the axial opposite direction. The support section is designed as a support ring, in particular an annular support plate, wherein the support ring is arranged to be coaxial with the cylindrical extension. In particular, the support ring is supported on a radial outer circumference of the cylindrical extension and thus extends radially outward. Alternatively, the support ring is supported on a radial inner circumference of the cylindrical extension and thus extends radially inward.

According to this embodiment, it is provided that the support ring is captively held by a securing means. In particular, the support ring is captively held in the axial opposite direction by the securing means and can optionally rest against the housing section, for example against a shoulder, in the axial direction. The cylindrical extension is preferably offset in the axial direction relative to the housing section, so that the shoulder is formed. The shoulder is preferably designed as an annular shoulder that encircles the main axis of rotation. Particularly preferably, the support ring is arranged in a form-fitting manner between the securing means and the shoulder in the axial direction with respect to the main axis of rotation. In particular, the securing means is designed as a securing ring, in particular as a snap ring. The cylindrical extension preferably has a securing means receptacle, in particular a circumferential groove, which serves to receive the securing means. During assembly, the actuating piston and the spring device are first inserted into the housing section. The support ring is then placed on the extension, wherein the spring device is biased between the two support surfaces and the support ring is secured against loss by means of the securing means.

An actuating device is thus proposed which is distinguished by particularly simple assembly. In addition, the spring device can be particularly easily supported on the housing section by the securing ring.

Another object of the disclosure relates to a transmission arrangement with the actuating device and with the multi-plate device as previously described. In particular, the transmission arrangement is arranged and/or can be arranged in a drive train of a vehicle. The transmission arrangement is preferably designed as a dual clutch transmission. In particular, the multi-plate device serves as a starting or switching element for the vehicle.

The multi-plate device has an inner multi-plate carrier and an outer multi-plate carrier, wherein multiple inner multi-plates are arranged on the inner multi-plate carrier and multiple outer multi-plates are arranged on the outer multi-plate carrier, which are arranged in an axially alternate manner. In particular, one of the two multi-plate carriers, in particular the outer multi-plate carrier, is non-rotatably connected to the housing section and/or is arranged to be stationary with respect to the housing section so that the multi-plate device functions as a multi-plate brake. Preferably, the other of the two multi-plate carriers can be rotated about the main axis of rotation or is rotatably connected to a rotating shaft.

According to this embodiment, the inner plates and the outer plates for closing the multi-plate device can be acted upon by the actuating force via the actuating piston. In particular, the actuating piston, in particular one of the two cylinder sections, is supported on one of the outer or inner plates. The inner and/or outer plates preferably have a friction lining. When the actuating force is applied to the multi-plate brake, the outer and inner plates are axially pressed together and a frictional connection is generated.

In a further embodiment it is provided that the transmission device has a further multi-plate device and a further actuating device for actuating the further multi-plate device. In particular, the two multi-plate devices and/or the two actuating devices are each arranged to be coaxial and/or concentric to one another with respect to the main axis of rotation. Preferably, the two multi-plate devices and/or the two actuating devices are constructed identically. In particular, both multi-plate devices are each designed as a multi-plate brake. For this purpose, one of the two multi-plate carriers, preferably the outer multi-plate carrier, of the further multi-plate device can also be connected non-rotatably to the housing section and/or be arranged in a stationary manner relative to the housing section.

According to this embodiment, it is provided that the actuating device and the further actuating device are fixed to a housing of the transmission arrangement, wherein the housing comprises the housing section of the actuating device and a further housing section of the further actuating device. In particular, the housing is designed as a bell housing, wherein the multi-plate brake and the actuating device are arranged radially outside the bell housing and the further multi-plate brake and the further actuating device are arranged radially inside the bell housing. In particular, the two actuating devices are arranged on a common side of the housing. Further actuating devices for further plates, brake, and/or clutch devices can particularly preferably be assigned to the housing.

It is thus a consideration of the disclosure to propose a transmission arrangement which is distinguished by a particularly compact construction.

In a further specification, it is provided that the cylindrical extension of the clutch housing forms an outer multi-plate carrier for the further multi-plate device on the radial inside thereof and carries the support section on the radial outside thereof. In particular, the cylindrical extension has a driving contour on the inner circumference thereof for the outer plates of the further multi-plate device. The two multi-plate devices and the two actuating devices are preferably spatially separated from one another by the cylindrical extension.

A transmission arrangement is thus proposed which is distinguished by a design that is particularly space-optimized.

### BRIEF DESCRIPTION OF THE DRAWINGS

Further features, advantages and effects of the disclosure are set out in the following description of the preferred exemplary embodiments of the disclosure. In the figures:

FIG. 1 shows a schematic, sectional view of a transmission arrangement as an exemplary embodiment; and

FIG. 2 shows a schematic sectional view of the actuating device of the transmission arrangement from FIG. 1 as a further exemplary embodiment.

### DETAILED DESCRIPTION

Parts that correspond to each other or are identical are marked with the same reference symbols in the figures.

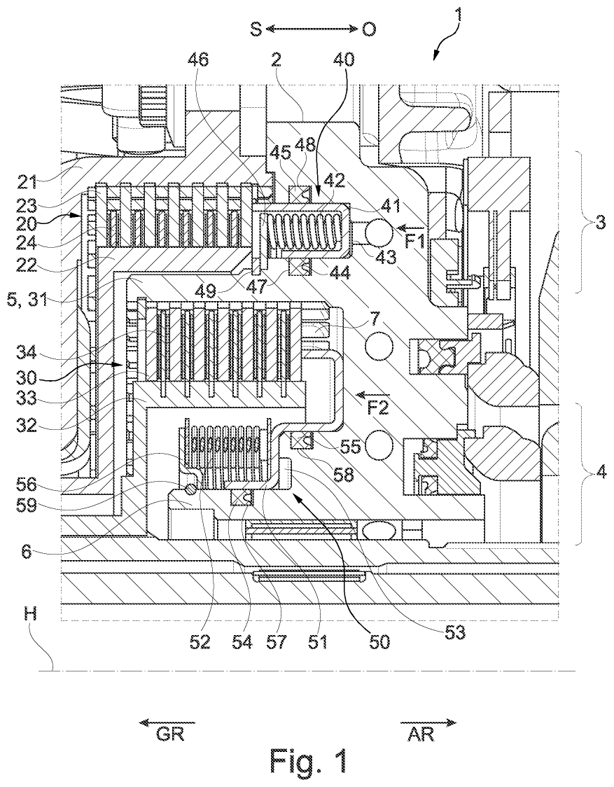

FIG. 1 shows, in a schematic sectional illustration, a detailed view of a transmission arrangement 1 which, for example, is designed and/or suitable for a drive train of a vehicle. The transmission arrangement 1 is designed as what is termed a dual clutch transmission, wherein the transmission arrangement 1 for this purpose has a first and a second multi-plate device 20, 30, as a multi-plate device and a further multi-plate device, as well as having a first and a second actuating device 40, 50, as an actuating device and another actuator. The first actuating device 40 serves to transmit a first actuating force F1 to the first multi-plate device 20 and the second actuating device 50 serves to transmit a second actuating force F2 to the second multi-plate device 30.

The two multi-plate devices 20, 30 each have an outer multi-plate carrier 21, 31 and an inner multi-plate carrier 22, 32, wherein the two outer multi-plate carriers 21, 31 each have multiple outer plates 23, 33 and the two inner multi-plate carriers 22, 32 each have multiple inner plates 24, 34. The outer plates 23, 33 and the inner plates 24, 34 are each arranged alternately one behind the other in the axial direction with respect to a main axis of rotation H. For example, the inner plates 24, 34 are designed as friction plates and the outer plates 23, 33 as steel plates, wherein a frictional connection is formed when the respective actuating force F1, F2 is applied.

The transmission arrangement 1 has a housing 2 which is designed as a bell housing of the transmission arrangement 1. The two multi-plate devices 20, 30 are each designed as a multi-plate brake, wherein the two outer multi-plate carriers 21, 31 are fixed to the housing, in particular non-rotatably connected to the housing 2, in the transmission arrangement 1. The two inner multi-plate carriers 22, 32 are each connected to a shaft rotating about the main axis of rotation H, not shown, which can be braked by the respective associated multi-plate brake 20, 30 when the actuating device 40, 50 is actuated.

The housing 2 has a first housing section 3 belonging to the first actuating device 40 and a second housing section 4 belonging to the second actuating device 50, wherein the two housing sections 3, 4 are arranged on a common side of the housing 2. The two housing sections 3, 4 each have a cylindrical extension 5, 6 which extend in the axial direction with respect to the main axis of rotation H and/or are arranged concentrically to one another. The first multi-plate device 20 is arranged radially outside and the second multi-plate device 30 is arranged radially inside the housing 2, wherein the cylindrical extension 5 of the first housing section 3 extends coaxially between the two multi-plate devices 20, 30 with respect to the main axis H. In the exemplary embodiment shown, the outer multi-plate carrier 31 of the second multi-plate device 30 is formed by the cylindrical extension 5 of the first housing section 3, wherein the cylindrical extension 5 has a driving contour 7 for the outer plates 33 of the second multi-plate device 30 on the inner circumference thereof.

The two actuating devices 40, 50 each have an actuating piston 41, 51, a spring device 42, 52, a pressure chamber 43, 53, an inner sealing device 44, 54, and an outer sealing device 45, 55, as well as one support section 46, 56 each.

The two actuating pistons 41, 51 are each designed as an annular piston encircling the main axis of rotation H, wherein the two actuating pistons 41, 51 are arranged to be coaxial and/or concentric to one another with respect to the main axis of rotation. The first actuating piston 41 serves to transmit the first actuating force F1 to the first multi-plate device 20 and the second actuating piston 51 serves to transmit the second actuating force F2 to the second multi-plate device 30. For this purpose, the two actuating pistons 41, 51 are each mounted displaceably in the axial direction with respect to the main axis of rotation H between a closed position S and an open position 0 on the respective associated housing section 3, 4. The actuating force F1, F2 is transmitted in the closed position S so that the respectively associated multi-plate device 20, 30 is closed and a braking torque is generated. In the open position 0, the respective associated multi-plate device 20, 30 is open.

The two pressure chambers 43, 53 are each designed as an annular chamber encircling the main axis of rotation H, wherein the two pressure chambers 43, 53 are each delimited by the associated housing section 3, 4 and the associated actuating piston 41, 51. The two pressure chambers 43, 53 are each filled with a fluid, in particular a hydraulic fluid, wherein the respective actuating piston 41, 51 is transferred from the open position 0 to the closed position S when the fluid pressure in the pressure chambers 43, 53 increases. For example, the two pressure chambers 43, 53 are each fluidically connected via a hydraulic path to a master cylinder, not shown, wherein, when the master cylinder is actuated, a hydraulic column is displaced in the direction of the associated actuating device 40, 50, whereby the fluid pressure is increased.

To seal the pressure chambers 43, 53, the two actuating pistons 41, 51 each rest sealingly on the associated inner sealing device 44, 54 and on the associated outer sealing device 45, 55, wherein the sealing devices 44, 45; 54, 55 are each fixed to the associated housing section 3, 4. For this purpose, the first and second housing sections 3, 4 each have an inner seal receptacle 47, 57 for receiving the inner sealing device 44, 54 and an outer seal receptacle 48, 58 for receiving the outer sealing device 45, 55. The seal receptacles 47, 48; 57, 58 are each as annular grooves and the sealing devices 44, 45; 54, 55 each designed as groove sealing rings, wherein the groove sealing rings are received in a captively held manner in the respective associated annular groove.

The two support sections 46, 56 are each designed as a support ring, for example an annular support plate, wherein the two support sections 46, 56 are each arranged on an outer circumference of the associated cylindrical extension 5, 6 and captively held on this via a securing means 49, 59. The two support sections 46, 56 extend with respect to the main axis of rotation H, at least in sections, each within a radial plane, wherein the respective associated spring device 42, 52 is supported in an axial direction AR on the associated actuating piston 41, 51 and equally supported in an axial opposite direction GR on the associated support section 46, 56, in particular at the same height in the radial direction.

The spring devices 42, 52 each serve to reset the associated actuating piston 41, 51 from the closed position S to the open position 0, wherein the spring devices 42, 52 for this purpose apply a pressure force to the respective actuating piston 41, 51 in the axial direction AR. The spring devices 42, 52 comprise several compression springs, for example helical springs, which are arranged uniformly spaced apart from one another or distributed between the support section 46, 56 and the associated actuating piston 41, 51 in the direction of rotation about the main axis of rotation H.

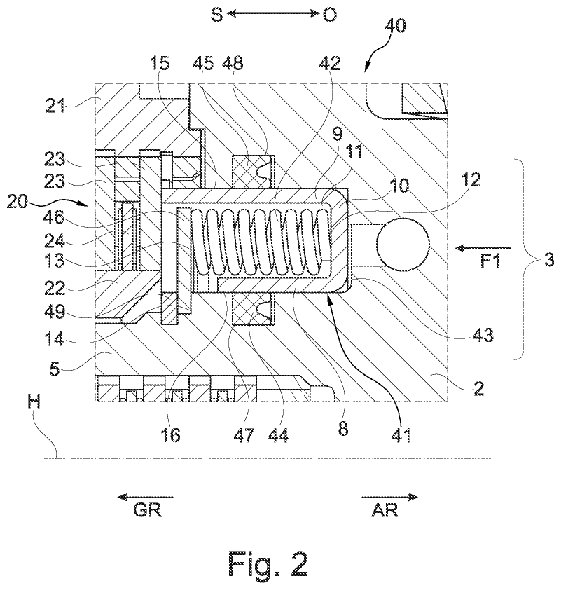

FIG. 2 shows a detailed view of the first actuating device 40 from FIG. 1 as an exemplary embodiment. The actuating piston 41 has an inner and an outer cylinder section 8, 9 and a radial section 10, wherein the two cylinder sections 8, 9 are connected to one another via the radial section 10. For example, the actuating piston 41 is designed as a sheet metal ring piston, wherein the two cylinder sections 8, 9 and the radial section 10 are formed by reshaping. The two cylinder sections 8, 9 are arranged to be concentric to one another with respect to the main axis of rotation H, wherein an annular intermediate space 11, in particular surrounding the main axis of rotation H, is formed between the two cylinder sections 8, 9. The intermediate space 11 is delimited in the radial direction by the two cylinder sections 8, 9 and in the axial direction AR by the radial section 10 and in the axial opposite direction GR by the support section 46.

The spring device 42 is arranged within the intermediate space 11, wherein the spring device 42, in particular the compression springs, are axially aligned. To support the spring device 42 in the axial direction AR, the radial section 10 has a first support surface 12 and for support in the axial opposite direction GR, the support section 46 has a second support surface 13. The two support surfaces 12, 13 are each defined as a circular ring surface and are arranged to be axially opposite one another. The two support surfaces 12, 13 are arranged to be overlapping or congruent with one another in the radial direction with respect to the main axis of rotation H so that the spring device 42, in particular the compression springs, can be supported equally in the axial direction AR and in the axially opposite direction GR. A particularly compact design of the first actuating device 40 is thus implemented, wherein the arrangement of the spring device 42 radially inside the actuating piston 41 enables a significant saving of radial installation space.

To transmit the actuating force F1, the outer cylinder section 9 is designed to be longer in the axial opposite direction GR than the inner cylinder section 8, wherein the outer cylinder section 9 extends in the direction of the multi-plate brake 20 over the support section 46. The support section 13 is thus arranged radially inside the outer cylinder section 9 and, at least in the closed position S, rests against one of the outer plates 23 in the axial opposite direction GR. The inner cylinder section 8, on the other hand, extends between the support section 46 and the housing section 3, wherein the inner cylinder section 8 can be displaced to a limited extent between the support section 46 and the housing section 3.

The cylindrical extension 5 of the first housing section 3 is offset towards the pressure chamber 43 so that a shoulder 14 is formed. For example, the shoulder 14 is designed as an annular shoulder encircling the main axis of rotation H, wherein the support section 46 designed as a support ring rests against the shoulder 14 in the axial direction and is secured by the securing means 49 in the axial opposite direction GR. For example, the securing means 49 is designed as a securing ring, in particular a snap ring, and is fixed in a corresponding receptacle on the cylindrical 5.

When the actuating force F1 is transmitted, the actuating piston 41 is transferred from the open position 0 to the closed position S, whereby the outer plates 23 and the inner plates 24 are axially pressed together and the braking torque is transmitted to the inner multi-plate carrier 22. To open the multi-plate device 20, the fluid pressure in the pressure chamber 43 is reduced, wherein the actuating piston 41 is automatically pushed back into the open position by the spring device 42. During the axial displacement thereof, the actuating piston 41 runs against the outer sealing device 45 with an outer jacket surface of the outer cylinder section 9 and against the inner sealing device 44 with an inner jacket surface of the inner cylinder section 8. The outer cylinder section 9 forms an outer sealing surface 15 with the outer circumferential surface thereof, and the inner cylinder section 8 forms an inner sealing surface 16 with the inner circumferential surface thereof.

### LIST OF REFERENCE SYMBOLS

1 Transmission assembly
2 Housing
3 First housing section
4 Second housing section
5 First cylindrical extension
6 Second cylindrical extension
7 Driving contour
8 Inner cylinder section
9 Outer cylinder section
10 Radial portion
11 Intermediate space
12 First support surface
13 Second support surface
14 Shoulder
15 Outer sealing surface
16 Inner sealing surface
20 First multi-plate device
21 Outer multi-plate carrier
22 Inner multi-plate carrier
23 Outer plate
24 Inner plate
30 Second multi-plate device
31 Outer multi-plate carrier
32 Inner multi-plate carrier
33 Outer plate
34 Inner plate
40 First actuating device
41 Actuating piston
42 Spring device
43 Pressure chamber
44 Inner sealing device
45 Outer sealing device
46 Support section
47 Inner seal receptacle
48 Outer seal receptacle
49 Securing means
50 Second actuating device
51 Actuating piston
52 Spring device
53 Pressure chamber
54 Inner sealing device
55 Outer sealing device
56 Support section
57 Inner seal receptacle
58 Outer seal receptacle
59 Securing means
H Main axis of rotation
O Open position
S Closed position
AR Axial direction
GR axial opposite direction
F1 First actuating force
F2 Second actuating force

1. An actuating device for a multi-plate device, the actuating device comprising:
an actuating piston for transmitting an actuating force to the multi-plate device;
a housing section
the actuating piston is received in the housing section so as to be axially displaceable between an open position and a closed position;
the housing section has a pressure chamber that is fillable with a fluid, and the actuating piston delimits the pressure chamber such that, when a fluid pressure of the fluid in the pressure chamber increases, the actuating piston is transferred from the open position to the closed position;
a spring for resetting the actuating piston from the closed position to the open position, wherein the spring is supported on the actuating piston via a first support surface and is supported on the housing section via a second support surface; and
the first and the second support surface are arranged axially opposite one another so that the spring is supported equally in an axial direction on the first support surface and in an axially opposite direction on the second support surface.

2. The actuating device according to claim 1, wherein the actuating piston comprises an annular piston and the pressure chamber is an annular space, the actuating piston has an inner and an outer cylinder section and a radial section connecting the two cylinder sections, an annular intermediate space is formed between the two cylinder sections, the spring is received in the intermediate space, and the first support surface is formed by the radial section.

3. The actuating device according to claim 2, further comprising an inner and an outer seal that seal the actuating piston from the housing section, the inner and the outer seals are fixed to the housing section.

4. The actuating device according to claim 3, wherein the outer cylinder section forms an outer sealing surface for the outer seal and the inner cylinder section forms an inner sealing surface for the inner seal so that, when the actuating piston is displaced, the outer seal sealingly abuts the outer sealing surface and the inner seal sealingly abuts the inner sealing surface.

5. The actuating device according to claim 1, further comprising a support section for supporting the spring, the second support surface is formed by the support section, and the support section is arranged on the housing section so as to protrude radially.

6. The actuating device according to claim 5, the actuating piston comprises an annular piston and the pressure chamber is an annular space, the actuating piston has an inner and an outer cylinder section and a radial section connecting the two cylinder sections, an annular intermediate space is formed between the two cylinder sections, the spring is received in the intermediate space, and the first support surface is formed by the radial section, one of the inner and the outer cylinder sections is longer than the other cylinder section, the longer cylinder section is arranged so as to be radially spaced apart from the support section so that the longer cylinder section is freely displaceable relative to the support section for transmitting the actuating force to a multi-plate brake.

7. The actuating device according to claim 6, wherein the housing section has a cylindrical extension, the support section comprises a support ring, and the support ring is arranged coaxially on the cylindrical extension and is held in a captive manner by a securing clip.

8. A transmission arrangement, comprising:
the actuating device according to claim 1; and
a multi-plate brake having at least one inner multi-plate carrier and at least one outer multi-plate carrier, a plurality of inner plates is arranged on the inner multi-plate carrier and a plurality of outer plates is arranged on the outer multi-plate carrier, the inner and outer plates are arranged in an axially alternating manner, and the inner plates and the outer plates are configured to be acted upon by the actuating force via the actuating piston.

9. The transmission arrangement according to claim 8, further comprising a further multi-plate device and a further actuating device for actuating the further multi-plate device, wherein the actuating device and the further actuating device are fixed together on a housing of the transmission arrangement, and the housing comprises the housing section of the actuating device and a further housing section of the further actuating device.

10. The transmission arrangement according to claim 9, wherein the housing section has a cylindrical extension that forms an outer multi-plate carrier for the further multi-plate brake on a radial inside thereof and carries the support section of the actuating device on a radial outside thereof.

11. An actuating device for a multi-plate brake, the actuating device comprising:
an actuating piston for transmitting an actuating force to the multi-plate brakes;
a housing section;
the actuating piston is received in the housing section so as to be axially displaceable between an open position and a closed position;
the housing section has a pressure chamber that is fillable with a fluid, and the actuating piston delimits the pressure chamber such that, when a fluid pressure of the fluid in the pressure chamber increases, the actuating piston is transferred from the open position to the closed position;
a spring for resetting the actuating piston from the closed position to the open position, wherein the spring is supported on the actuating piston via a first support surface and is supported on the housing section via a second support surface;
the first and the second support surface are arranged axially opposite one another so that the spring is supported therebetween in an axial direction; and
the second support surface is formed by a support ring that is removably attachable to the housing section.

12. The actuating device of claim 11, wherein the actuating piston comprises an annular piston and the pressure chamber is an annular space, the actuating piston has an inner and an outer cylinder section and a radial section connecting the two cylinder sections, an annular intermediate space is formed between the two cylinder sections, the spring is received in the intermediate space, and the first support surface is formed by the radial section.

13. The actuating device of claim 12, further comprising an inner and an outer seal that seal the actuating piston from the housing section, the inner and the outer seals are fixed to the housing section.

14. The actuating device of claim 13, wherein the outer cylinder section forms an outer sealing surface for the outer seal and the inner cylinder section forms an inner sealing surface for the inner seal so that, when the actuating piston is displaced, the outer seal sealingly abuts the outer sealing surface and the inner seal sealingly abuts the inner sealing surface.

15. The actuating device of claim 11, wherein the support ring protrudes radially from the housing section.

16. The actuating device according to claim 15, wherein the actuating piston comprises an annular piston and the pressure chamber is an annular space, the actuating piston has an inner and an outer cylinder section and a radial section connecting the two cylinder sections, an annular intermediate space is formed between the two cylinder sections, the spring is received in the intermediate space, and the first support surface is formed by the radial section, one of the inner and the outer cylinder sections is longer than the other cylinder section, the longer cylinder section is arranged so as to be radially spaced apart from the support ring so that the longer cylinder section is freely displaceable relative to the support ring for transmitting the actuating force to the multi-plate brake.

17. The actuating device of claim 11, wherein the housing section has a cylindrical extension, and the support ring is arranged coaxially on the cylindrical extension and is held thereto by a securing clip.
